(19) United States
(12) Patent Application Publication
(10) Pub. No.: US 2010/0301829 A1
(43) Pub. Date: Dec. 2, 2010

(54) BATTERY POWER SUPPLY FOR RADIOFREQUENCY TRANSMITTER

(75) Inventor: Serge Bulteau, Julienas (FR)

Correspondence Address: DORITY & MANNING, P.A., POST OFFICE BOX 1449, GREENVILLE, SC, 29602-1449, US

(73) Assignee: ACTARIS S.A.S., Boulogne-billancourt (FR)

(21) Appl. No.: 12/863,635

(22) PCT Filed: Jan. 8, 2009
(86) PCT No.: PCT/EP2009/050147

§ 371 Date: Aug. 24, 2010

(30) Foreign Application Priority Data
Jan. 25, 2008 (EP) 08305009.6

(51) Int. Cl. G05F 3/02

(52) U.S. Cl. 323/304

(57) ABSTRACT

The invention relates to a power supply device for an RF transmitter (5), the device comprising at least one battery (2) and at least one capacitor (3) electrically connected in parallel between the battery (2) and the RF transmitter (5), and voltage-raising means (4′) for charging the capacitor (3) to a storage voltage (V_{C}) higher than the voltage delivered by the battery during an initial charging stage, the voltage-raising means (4′) comprising an inductor (L) and a diode (D) in series, and associated with a switch (40′) suitable, during the storage stage, for periodically causing energy to be accumulated in the inductor (L) followed by transferring the accumulated energy into the capacitor (3). According to the invention, a switch-control signal (S_{C}) is predetermined and of variable period so as to act, during each period, to cause: the switch (40′) to close over a fixed duration that is calculated so as to enable the current flowing in the inductor (L) to increase from a value of zero up to a predefined limit value; and the switch (40′) to open over a duration that is variable and a function of the voltage (V_{C}) across the capacitor (3), the duration being defined in such a manner as to enable the current flowing in the inductor (L) to decrease from said predefined limit value to a value of zero.

The present invention relates to radiofrequency (RF) transmitter modules that are powered by means of at least one battery.

A field of application to which the invention applies particularly, but in non-limiting manner, is that of radio modules used for remotely reading energy meters, of the water, heat, gas, or electricity meter type.

In this field of application, the mean level of energy consumption remains rather low, which generally makes it possible to use small capacity batteries of small size, e.g. a 3.6 volt (V) AA battery. Nevertheless, at the moment when the module is transmitting an RF signal, the battery must be capable of delivering an instantaneous current that is rather high (of the order of a few hundreds of milliamps (mA)) over a short duration, e.g. of the order of 1 minute. The power required at that moment may be incompatible with using a battery of small size and small capacity, and it is often necessary to find a compromise between the power to be delivered, the size of the battery, the operating temperature range, and the lifetime of the module, so as to guarantee the characteristics of the battery throughout the operating duration of the module.

Furthermore the internal impedance of the battery will lead to a voltage drop that increases with increasing current peak, and it is therefore generally desirable to use batteries presenting the lowest possible internal impedances.

A first solution consists in overdimensioning the battery. Naturally, that solution is disadvantageous, not only in terms of bulk, but also in terms of efficiency since, under such circumstances, only a fraction of the available capacity in the battery is ever used, with the remainder being of no use.

Another known solution, e.g. as disclosed in document EP 0 718 951, consists in associating a battery with an assistance circuit that comprises a rechargeable battery and one or more supercapacitors, the assistance circuit being permanently connected in parallel between the battery and the RF transmission module that is to be powered. Except during stages of transmission, the assistance circuit is constantly charged so as to be capable of delivering the power it has accumulated at the time of transmission, while limiting the power that the battery needs to deliver at the time of the current peak.

Nevertheless, that solution suffers from certain drawbacks:

Firstly, the components involved in the assistance circuits are expensive and difficult to find on the market with the required values.

In addition, the reliability of the components is not guaranteed over operating durations of several years or even several tens of years, corresponding to the conventional lifetime that needs to be guaranteed for remote-reading modules. Furthermore, their performance degrades rapidly over time. In particular, their equivalent series resistance (ESR) increases over time, thereby limiting their effectiveness at the moment when the current peak needs to be delivered.

Furthermore, those components generally present a high level of leakage current, which means that the battery needs to be overdimensioned in order to mitigate the resulting loss of energy.

Finally, for the values involved, the supercapacitors used in those solutions remain components that are not sufficiently compact.

A third known solution, described in particular in document EP 0 613 257, consists in charging a standard capacitor to a storage voltage that is higher than the voltage of the battery, and then in delivering the current peak at the end of charging and at a voltage that is lower than the storage voltage of the capacitor. More precisely, that document describes a power supply device for an RF transmitter module, the device comprising at least one battery and at least one capacitor forming an energy storage circuit that is electrically connected in parallel between the battery and the RF transmitter module, the power supply device further comprising:
a DC-DC voltage-raising converter for acting during an initial capacitor-charging stage to charge the capacitor to a storage voltage that is higher than the voltage delivered by the battery;
a controlled voltage-regulator in series between the capacitor and the RF transmitter module to discharge the capacitor and lower the storage voltage to a predetermined voltage value for delivering power to the module during a discharge stage; and
a control module suitable firstly for disconnecting the module from the capacitor during the initial charging stage, and secondly for disconnecting the DC-DC voltage converter from the battery during the discharge stage.

The description below relates more particularly to the voltage-raising means that are used between the battery and the storage capacitor.

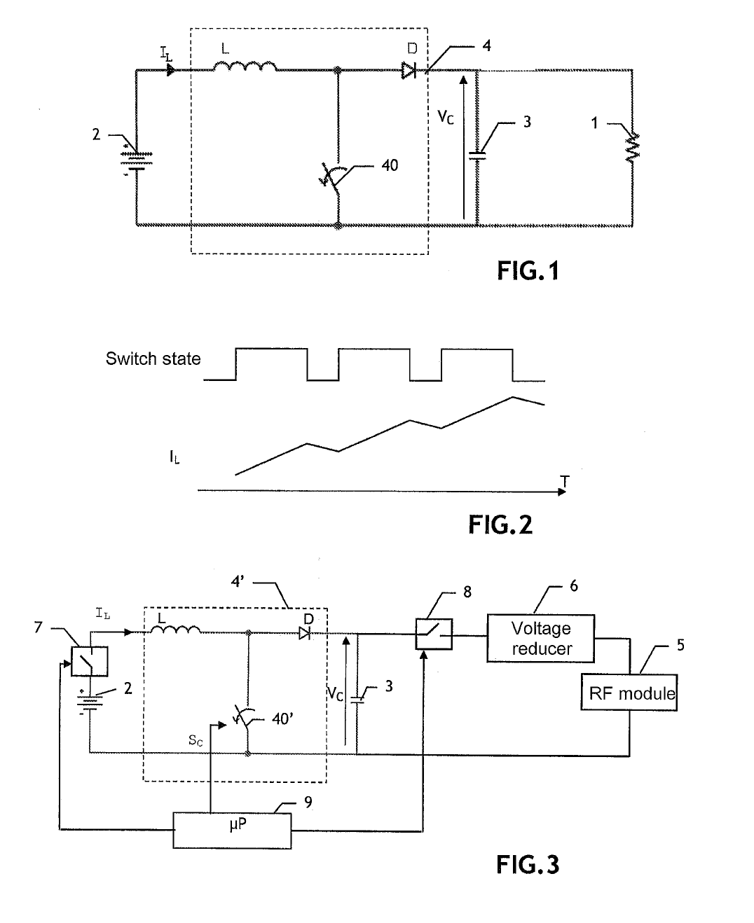

A DC-DC voltage-raising converter as recommended in document EP 0 613 257 is generally used in the circuit configuration shown in the wiring diagram of FIG. 1. In this figure, a load 1 is connected across the terminals of a battery 2 that charges a capacitor 3 via a DC-DC voltage-raising converter 4. The voltage-raising converter 4 essentially comprises an inductor L and a diode connected in series, together with control means (not shown) for controlling a switch 40. FIG. 2 shows how the closed/open state of the switch 40 varies over time, together with the corresponding current I_{L} flowing through the inductor L during the capacitor-charging stage. So long as the voltage V_{C} across the terminals of the capacitor 3 remains lower than the desired storage voltage value, the switch 40 is controlled so as to occupy in alternation a closed state (represented by convention as the high state in FIG. 2), and an open state (represented by convention as a low state in FIG. 2). When the switch 40 is in the closed state, the current I_{L} flowing in the inductor L increases by a value that is proportional to the duration for which the switch has been closed. When the switch 40 is in the open state, the current I_{L} charges the capacitor 3 through the diode D. The current I_{L} therefore decreases by a value proportional to the duration during which the switch 40 remains open.

In conventional DC-DC converters, the switch is controlled by means of an oscillator that generates a squarewave periodic control signal of constant period, corresponding to that shown in FIG. 2. When the voltage V_{C} reaches the desired value, generation of the control signal is interrupted. As soon as the voltage V_{C} decreases as a result of the load 1 being activated, generation of the switch control signal is reactivated.

The above operation is optimized so as to make it possible to deliver a current peak to the load once the capacitor has been charged, and then to maintain the storage voltage at the desired value, regardless of the value of the current demanded by the load. Thus, on starting, the current I_{L} increases without any particular limit, and under steady conditions, the voltage V_{C} remains constant and the current I_{L} flowing in the inductor is a direct function of the load current.

Nevertheless, the above operation is not suitable for the applications under consideration herein where the voltage-raising converter is connected to the battery to charge the capacitor even when no load (here the RF transmitter module) has yet been connected, and is then disconnected from the battery when the desired storage voltage V_{C} is reached and the capacitor is connected to the load.

In addition, known circuits generally do not make it possible to limit the battery current during the capacitor-charging stage. In order to avoid stressing the battery, is it therefore necessary under such circumstances to provide either a current generator or a current limiter between the battery and the voltage-raising converter. In addition to the fact that that increases the cost of the power supply device by adding an additional component, a current generator or a limiter gives rise to losses that reduce efficiency in terms of energy transfer.

Some known voltage-raising converters incorporate a current-limiting function, however those converters are not numerous and they are more expensive.

An object of the present invention is to provide, at low cost, a power supply device using voltage-raising means associated with a special type of control that makes it possible in particular to have full control over the battery current during the capacitor-charging cycle.

More precisely, the invention provides a power supply device for an RF transmitter module, the device comprising at least one battery and at least one capacitor forming an energy storage circuit electrically connected in parallel between the battery and the RF transmitter module, the power supply device also including voltage-raising means for charging the capacitor to a storage voltage that is higher than the voltage delivered by the battery during an initial charging stage, the voltage-raising means comprising an inductor and a diode connected in series between the battery and the capacitor, and switch means suitable for acting during the initial charging stage to cause energy to be accumulated periodically in the inductor, and then to cause the accumulated energy to be transferred into the capacitor, the device also including a control module suitable for generating a control signal for the switch means, firstly to disconnect the capacitor from the RF transmitter module during the initial capacitor-charging stage, and secondly to disconnect the voltage-raising means from the battery during a subsequent capacitor discharge stage, the device being characterized in that said control signal is predetermined and of variable period, and is suitable, during each period, to cause:
said switch means to close over a fixed duration calculated so as to enable the current flowing through the inductor to increase from a value of zero up to a predefined limit value; and
said switch means to open over a duration that is variable and a function of the voltage across the terminals of the capacitor, and that is defined in such a manner as to enable the current flowing through the inductor to decrease from said predefined limit value to a value of zero.

In a preferred embodiment, the power supply device further comprises a controlled voltage regulator suitable for being connected in series between the capacitor and the RF transmitter module, said regulator reducing the stored voltage to a predetermined voltage value for powering the module during the discharge stage.

The control module is preferably adapted to trigger said charging stage immediately prior to delivering the current peak, at an instant that is soon enough before the current peak delivery instant to enable the capacitor to be charged completely.

The invention also provides a remote-reading module for metering energy, and including such a power supply device.

The invention and the advantages it provides can be better understood from the following description of a preferred embodiment of a power supply device in accordance with the invention, given with reference to the accompanying figures, in which:

FIG. 1 is a diagram of a prior art battery power supply device for an RF transmitter, the device including a DC-DC voltage converter used as voltage-raising means;

FIG. 2 is a timing chart showing how the FIG. 1 converter is controlled and the corresponding appearance of the capacitor charging current;

FIG. 3 is a diagram of a battery power supply device for an RF transmitter in a preferred embodiment of the invention;

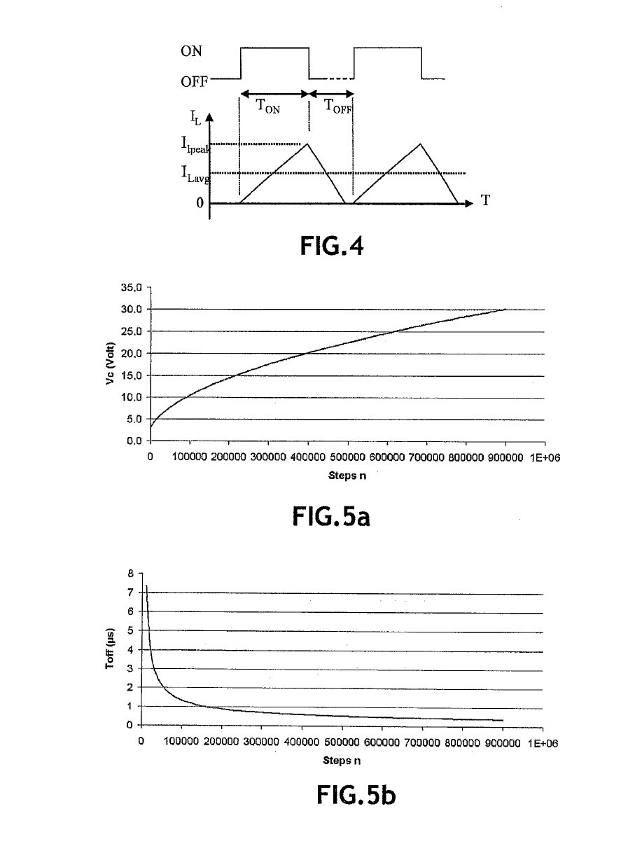

FIG. 4 is a timing chart showing the particular way in which the FIG. 3 voltage-raising means are controlled and the corresponding appearance of the capacitor charging current; and

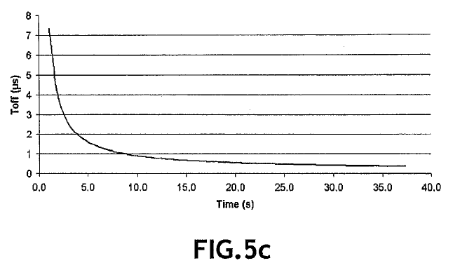

FIGS. 5a to 5c are graphs showing how the voltage stored in the capacitor and how one of the parameters of the control signal vary over time, the graphs being obtained by simulation.

FIG. 3 is a diagram of a power supply device constituting the preferred embodiment of the invention. The device serves to charge a standard storage capacitor 3 from a battery 2 via voltage-raising means 4′, and then to discharge the capacitor 3 when the RF module 5 is activated. The device preferably also includes, downstream from the storage capacitor, voltage-reducing means 6 making it possible, while discharging the capacitor 3 to feed the RF module 5, to step down from the stored voltage to the voltage needed by the module. It is also recalled that, in the preferred embodiment, the RF module is not connected to the capacitor during the charging stage and that during the stage in which the capacitor is discharged, the capacitor is no longer connected to the battery 2. This is made possible by two switch means 7 and 8 that are controlled by a control module 9 of the microprocessor type.

Below, attention is given solely to what happens during the stage of charging the capacitor (switch means 7 closed and switch means 8 open).

The voltage-raising means 4′ used in accordance with the invention and shown diagrammatically in FIG. 3 are structurally rather similar to the voltage-raising converter 4 described with reference to FIG. 1, given that they include an inductor L and a diode D connected in series between the battery 2 and the storage capacitor 3, together with a switch 40′. Nevertheless, the analogy with the DC-DC converter stops there. In the preferred, but non-limiting, application that is envisaged, the role of the voltage-raising means 4′ is to raise the voltage of the battery, typically of the order of 3 V, to a predefined voltage value, typically lying in the range 30 V to 60 V, during the capacitor-charging stage. It is also desired to limit the current to a value that lies, for example, at 10 mA.

The special feature of the invention lies in the way in which the switch 40′ is controlled during a capacitor-charging stage, its control signal advantageously being delivered by the microprocessor type control module 9 that is already present in the device. This is described below with reference to FIG. 4.

As in FIG. 2, the control signal S_{C} is a periodic signal that alternates between durations T_{ON} during which the switch 40′ is closed and durations T_{OFF} during which the switch 40′ is open, however the period of the control signal is variable. More precisely, throughout the duration corresponding to a stage or cycle of charging the capacitor 3, the duration T_{ON} during which the switch 40′ is in the closed state is fixed from one period to the next, and corresponds to a predetermined value that enables the current I_{L} to vary from a value of zero to a predefined value I_{Lpeak} corresponding to the maximum permitted value that is compatible with what the battery can withstand.

In contrast, the duration T_{OFF} during which the switch 40′ is in the open state is variable from one period to the next, with the variation being calculated in such a manner as to enable the current I_{L} through the inductor L to decrease down to zero. Thus, during the following duration T_{ON} it is guaranteed that the current I_{L} will indeed start from a value of zero, and that the average current I_{Lavg} through the inductor L does not increase.

The current increase ΔI_{L}+ in the inductor L during the duration T_{ON} is given by the following relationship:

$$Δ {I}_{L} += ( {I}_{Lpeak} - 0 ) = \frac{{V}_{D C}}{L} {T}_{ON} \qquad ( I )$$

where V_{DC} is the voltage across the terminals of the battery 2.

In relationship (I), the values of V_{DC} and of L are constant, and the value of I_{Lpeak} is predetermined, thus making it possible to calculate the fixed value T_{ON}.

Using the following values that are taken by way of example:

L=1 millihenries (mH)

C (capacitance of the capacitor 3)=1 millifarads (mF)

V_{DC}=3 V

I_{Lpeak}=10 mA=2×I_{Lavg}

The following is obtained: T_{ON}=3.33 microseconds (μs).

Furthermore, during the duration T_{OFF}, the current flowing in the inductor decreases by a value ΔI_{L}− that is equal to the current increase ΔI_{L}+, and that can be written using the following relationship:

$$Δ {I}_{L} -= \frac{{V}_{C} - {V}_{D C}}{L} {T}_{OFF} = Δ {I}_{L} + \qquad ( II )$$

In relationship (II), the values of V_{DC} and of L are constant, and the value ΔI_{L}+ is predetermined such that the duration T_{OFF} depends only on the voltage V_{C} across the terminals of the capacitor 3.

The relationship for varying the voltage V_{C} can be determined from the following relationship that expresses the energy transferred by the inductor L to the capacitor 3 between two successive periods of the control signal:

$$\frac{1}{2} {LI}_{L}^{2} = \frac{1}{2} C ( {V}_{C ( n )}^{2} - {V}_{C ( n - 1 )}^{2} ) \qquad ( III )$$

where the index n corresponds to the current period of the control signal, and the index (n−1) represents the preceding period.

By combining the relationships (II) and (III) it is thus possible to determine the value for T_{OFF} in each period of the control signal.

Although the duration T_{OFF} may be determined in real time by measuring the voltage V_{C} and then calculating the duration T_{OFF} by applying the above relationships, the present invention takes advantage of the fact that, in the intended application, the value desired for the voltage V_{C} at the end of the charging stage is known in advance, thereby making it possible to predefine the characteristics of the control signal S_{C} completely, i.e. its total duration (number of periods), and for each period, the durations T_{ON} and T_{OFF}.

FIGS. 5a to 5c show the results of a simulation taking the above-mentioned component values by way of non-limiting example, and setting the charged voltage V_{C} that is desired at the end of the charging stage at 30 V. More precisely:

FIG. 5a shows how the voltage V_{C} across the terminals of the capacitor (1 mF) varies as a function of the period, in application of above relationship (III);

FIG. 5b shows how the duration T_{OFF} varies as a function of the period (combining above relationships (II) and (III)); and

FIG. 5c shows how the duration T_{OFF} varies over time.

Thus, it can be seen that during a capacitor-charging stage, the duration T_{OFF} decreases over time.

The characteristics of the signal S_{C} are thus completely predefined, and they are stored in the device for use by the control module 9 on each charging cycle.

By means of the invention, it is ensured that the current delivered by the battery during the capacitor-charging stage is indeed limited to a maximum selected value, and this is achieved without it being necessary to use any expensive additional components.

Furthermore, by avoiding the use of additional components, energy losses are likewise limited to the contributions of the inductor L, the diode D, and the switch 40′, only. The device of the invention thus enables energy to be transferred efficiently, typically at better than 80%.

Furthermore, the total duration of the capacitor-charging stage, corresponding to the total predefined duration of the control signal S_{C}, is here reduced to the strict minimum since, during charging, the same mean current I_{Lavg} is always used.

Finally, the fact of knowing in advance the total duration required for charging the capacitor makes it possible, most advantageously, for the control module 9 to know exactly when it needs to trigger a capacitor charging stage by closing the switch means 7 and simultaneously opening the switch means 8. The control module 9 is thus suitable for triggering said first charging stage immediately before delivering the current peak, at an instant that is soon enough relative to the instant at which the current peak is delivered to ensure that the capacitor 3 is completely charged.

1-4. (canceled)

5. A power supply device for an RF transmitter module, the device comprising at least one battery and at least one capacitor forming an energy storage circuit electrically connected in parallel between the battery and the RF transmitter module, the power supply device also including voltage-raising means for charging the capacitor to a storage voltage that is higher than the voltage delivered by the battery during an initial charging stage, the voltage-raising means comprising an inductor (L) and a diode connected in series between the battery and the capacitor, and switch means suitable for acting during the initial charging stage to cause energy to be accumulated periodically in the inductor, and then to cause the accumulated energy to be transferred into the capacitor, the device also including a control module suitable for generating a control signal (S_{C}) for the switch means, firstly to disconnect the capacitor from the RF transmitter module during the initial capacitor-charging stage, and secondly to disconnect the voltage-raising means from the battery during a subsequent capacitor discharge stage, the device being characterized in that said control signal (S_{C}) is predetermined and of variable period, and is suitable, during each period, to cause:
said switch means to close over a fixed duration (T_{ON}) calculated so as to enable the current (I_{L}) flowing through the inductor to increase from a value of zero up to a predefined limit value (I_{Lpeak}); and
said switch means to open over a duration (T_{OFF}) that is variable and a function of the voltage (V_{C}) across the terminals of the capacitor, and that is defined in such a manner as to enable the current (I_{L}) flowing through the inductor to decrease from said predefined limit value (I_{Lpeak}) to a value of zero.

6. A power supply device according to claim 5, further including a controlled voltage regulator suitable for being connected in series between the capacitor and the RF transmitter module, said regulator reducing the stored voltage to a predetermined voltage value for powering the module during the discharge stage.

7. A power supply device according to claim 5, wherein said control module is adapted to trigger said charging stage immediately prior to delivering the current peak, at an instant that is soon enough before the current peak delivery instant to enable the capacitor to be charged completely.

8. A remote-reading module for an energy meter, including a power supply device according to claim 5.
